(19) United States
(12) Patent Application Publication
(10) Pub. No.: US 2026/0307984 A1
(43) Pub. Date: Oct. 8, 2026

(54) BIMETALLIC CATALYSTS SUPPORTED ON LANTHANUM MANGANITE (LaMnO3) FOR AMMONIA DECOMPOSITION

(71) Applicant: KING FAHD UNIVERSITY OF PETROLEUM AND MINERALS, Dhahran (SA)

(72) Inventors: M. Nasiruzzaman SHAIKH, Dhahran (SA); Afnan Mohammed AJEEBI, Dhahran (SA); Ahsan ALI, Dhahran (SA); Zain Hassan YAMANI, Dhahran (SA)

(73) Assignee: KING FAHD UNIVERSITY OF PETROLEUM AND MINERALS, Dhahran (SA)

(21) Appl. No.: 19/172,859

(22) Filed: Apr. 8, 2025

(51) Int. Cl. C01B 3/04; B01J 23/889; B01J 35/51; B01J 37/08; B01J 37/12

(52) U.S. Cl. CPC C01B 3/047; B01J 23/8892; B01J 35/51; B01J 37/086; B01J 37/12; C01B 2203/0277; C01B 2203/1058

(57) ABSTRACT

A method of ammonia (NH₃) decomposition includes flowing hydrogen (H₂) through a reactor containing a catalyst to reduce the catalyst and flowing an NH₃ mixture through the reactor at a temperature of 100 to 800 degrees Celsius (° C.) to decompose the NH₃. The catalyst is a metal-doped lanthanum manganite material (LaMnO₃) including cobalt (Co) and nickel (Ni) each in an amount of 0.1 to 2.0 percent by weight (wt. %) based on a total weight of the metal-doped LaMnO₃ material. The NH₃ mixture includes NH₃ and helium in a volumetric ratio of 5:95 to 15:85. At least 99 wt. % of NH₃ is decomposed to form H₂ and N₂ at a temperature of 550° C. based on an initial amount of the NH₃.

### STATEMENT OF ACKNOWLEDGEMENT

Support provided by the Hydrogen Consortium, King Fahd University of Petroleum and Minerals, Saudi Arabia, through Project H2FC2312 is gratefully acknowledged.

### BACKGROUND

### Technical Field

The present disclosure is directed towards a method for ammonia decomposition, and more particularly, towards a method of ammonia (NH₃) decomposition using bimetallic catalysts supported on lanthanum manganite (LaMnO₃).

### Description of Related Art

The “background” description provided herein is for the purpose of presenting the context of the disclosure generally. The work of the presently named inventors, to the extent it is described in this background section, as well as aspects of the description that may not otherwise qualify as prior art at the time of filing, are neither expressly nor impliedly admitted as prior art against the present disclosure.

Amidst growing global energy crises, reliance on fossil fuels presents a paradox of convenience marred by environmental degradation. This contradiction underscores an urgent, global shift towards cleaner energy sources for sustainable development [Junwen, C. et al., Current status and prospects of hydrogen storage and transportation technology, Acta Petrolei Sinica Petroleum Processing Section, 2021, 37, 6, 1461; and Wu, S. et al., Evaluation of fuel properties and combustion behavior of hydrochar derived from hydrothermal carbonisation of agricultural wastes, Journal of the Energy Institute, 2023, 108, 101209]. Energy derived from hydrogen is seen as a promising energy solution as it is a carbon-neutral and eco-friendly energy source. With an energy density that surpasses traditional fuels and a combustion process that emits nothing more harmful than water, hydrogen stands out for its environmental credentials; however, the path to a hydrogen economy is contingent upon overcoming hurdles in accelerating hydrogen production and reducing its cost [Gutiérrez, F. & Méndez, F., Entropy generation minimization for the thermal decomposition of methane gas in hydrogen using genetic algorithms, Energy Conversion and Management, 2012, 55, 1-13]. Addressing challenges will assist hydrogen in transitioning towards sustainable energy practices while simultaneously contributing to energy conservation and emission reduction efforts.

Interest in hydrogen energy as a carbon-free gas suitable for applications in fuel cells and internal combustion engines reflects environmental advantages. Inherent high reactivity of hydrogen gas raises safety concerns that underscore handling during usage, transportation, and storage. Hydrogen has been evaluated as a safer fuel option than both liquefied petroleum gas (LPG) and liquefied natural gas (LNG), but riskier than ammonia (NH₃), suggesting a nuanced spectrum of safety in the realm of clean energy sources [Jeong, S. Y. et al., Property-based quantitative risk assessment of hydrogen, ammonia, methane, and propane considering explosion, combustion, toxicity, and environmental impacts, Journal of Energy Storage, 2022, 54, 105344]. Transition to energy derived from hydrogen hinges on development and refinement of innovative storage solutions that can safely contain the highly reactive gas. Possible storage solutions may include storing hydrogen as a compressed gas in high-pressure tanks, as a liquid in cryogenic temperatures, and/or within chemical compounds like metal hydrides. These methods balance trade-offs between energy density, safety, and cost efficiency. Advancements in these storage technologies mitigate safety risks associated with hydrogen, paving the way for its broader adoption as a clean, sustainable energy solution. With ongoing innovation and rigorous safety protocols, hydrogen stands to play a role in a global shift towards a more sustainable energy landscape, demonstrating that with proper management, the benefits can far outweigh the challenges.

Exploration of ammonia (NH₃) as a medium for hydrogen storage is increasingly regarded as a promising avenue in the quest for efficient energy solutions due to its unique properties and advantages. Ammonia boasts a high hydrogen storage density due to its molecular composition, containing three hydrogen atoms per molecule. This characteristic enables NH₃ to serve as an effective storage medium, capable of holding substantial volumes of hydrogen under appropriate conditions. Ammonia's storage conditions are less demanding than those of other hydrogen carriers, requiring relatively low pressures to maintain stability. This translates into safer, more cost-effective storage and transportation solutions as it reduces the need for high-pressure equipment. Another advantage of NH₃ is an existing industrial infrastructure for its production and storage, which can be leveraged for hydrogen storage and offer a cost-efficient alternative to building new facilities from scratch. The compatibility of NH₃ synthesis with renewable energy sources, like wind, solar, and nuclear power, enhances the sustainability of energy systems and aligns with goals of an energy transition.

Ammonia also stands out for its long-term storage capabilities, maintaining stability over extended periods without large hydrogen leakage and/or degradation, making it a candidate for long-duration energy storage needs. Ammonia presents fewer safety risks compared to hydrogen gas due to its lower combustibility and higher boiling point, which simplifies safety protocols during handling and transportation. Collectively these attributes underscore the potential of NH₃ as a hydrogen storage medium in the development of a sustainable, efficient, and safe hydrogen economy.

In the past decade, there has been a focus the catalytic decomposition of NH₃ utilizing noble metal catalysts including ruthenium (Ru), platinum (Pt), rhodium (Rh), and palladium (Pd). Ruthenium has emerged as the most active and extensively studied catalyst [Kim, A. R. et al., Hydrogen production from ammonia decomposition over Ru-rich surface on La₂O₂CO₃—Al₂O₃ catalyst beads, Catalysis Today, 2023, 411, 113867; Hill, A. K. & Torrente-Murciano, L., Low temperature H₂ production from ammonia using ruthenium-based catalysts: Synergetic effect of promoter and support, Applied Catalysis B: Environmental, 2015, 172, 129-135; Sebastián, D. et al., Nitrogen doped ordered mesoporous carbon as support of PtRu nanoparticles for methanol electro-oxidation, Energies, 2018, 11, 4, 831; Nishi, M. et al., A super-growth carbon nanotubes-supported, Cs-promoted Ru catalyst for 0.1-8 MPaG ammonia synthesis, Journal of Catalysis, 2022, 413, 623-635; and Zhao, J. et al., Metal-support interactions on Ru/CaAlOx catalysts derived from structural reconstruction of Ca—Al layered double hydroxides for ammonia decomposition, Chemical Communications, 2019, 55, 96, 14410-14413]. Although catalysts derived from Ru have shown good performance, their elevated cost makes them less feasible for extensive-scale applications. Catalysts utilizing non-noble metals, such as nickel (Ni), ion (Fe), and cobalt (Co), have emerged as promising substitutes due to their performance. Continuous endeavors are directed towards diminishing expenses, enhancing activity, and prolonging operational longevity. Support materials may be used in combination with metal catalysts for ammonia decomposition.

Accordingly, an object of the present disclosure is to provide a method of NH₃ decomposition using bimetallic catalysts supported on lanthanum manganite (LaMnO₃), which may circumvent drawbacks and limitations, such as low efficiency and limited lifespan of catalysts, of the materials and methods known in the art.

### SUMMARY

In an exemplary embodiment, a method of ammonia (NH₃) decomposition is described. The method includes flowing hydrogen (H₂) through a reactor containing a catalyst to reduce the catalyst and flowing an NH₃ mixture through the reactor at a temperature of 100 to 800 degrees Celsius (° C.) to decompose the NH₃. The catalyst is a metal-doped lanthanum manganite material (LaMnO₃) including cobalt (Co) and nickel (Ni) each in an amount of 0.1 to 2.0 percent by weight (wt. %) based on a total weight of the metal-doped LaMnO₃ material. The NH₃ mixture includes NH₃ and helium in a volumetric ratio of 5:95 to 15:85. At least 99 wt. % of NH₃ is decomposed to form H₂ and N₂ at a temperature of 550° C. based on an initial amount of the NH₃.

In some embodiments, flowing H₂ through the reactor containing the catalyst to reduce the catalyst occurs at a reactor temperature of 300 to 750° C.

In some embodiments, a flow rate of the NH₃ mixture through the reactor is 30 to 40 milliliters per minute (mL/min).

In some embodiments, the metal-doped LaMnO₃ material is in the form of aggregated spheres having a longest dimension of 50 to 500 nanometers (nm).

In some embodiments, a flow rate of the H₂ through the reactor is 25 to 35 mL/min.

In some embodiments, the metal-doped LaMnO₃ material includes Co in an amount of 0.4 to 0.6 wt. % based on a total weight of the metal-doped LaMnO₃ material.

In some embodiments, the metal-doped LaMnO₃ material includes Co in an amount of 0.4 to 0.6 wt. % and Ni in an amount of 0.4 to 0.6 wt. % based on a total weight of the metal-doped LaMnO₃ material.

In some embodiments, the metal-doped LaMnO₃ material includes Co in an amount of 0.2 to 0.3 wt. % and Ni in an amount of 0.4 to 0.6 wt. % based on a total weight of the metal-doped LaMnO₃ material.

In some embodiments, the metal-doped LaMnO₃ material further comprises 0.1 to 1.0 wt. % ruthenium (Ru) based on a total weight of the metal-doped LaMnO₃ material.

In some embodiments, the metal-doped LaMnO₃ material includes Ru in an amount of 0.4 to 0.6 wt. % based on a total weight of the metal-doped LaMnO₃ material.

In some embodiments, the metal-doped LaMnO₃ material is in the shape of aggregated particles having a longest dimension of 50 to 1000 nm.

In some embodiments, at least 50 wt. % of NH₃ is decomposed to form H₂ and N₂ at a temperature of 450° C. based on an initial amount of the NH₃.

In some embodiments, at least 75 wt. % of NH₃ is decomposed to form H₂ and N₂ at a temperature of 475° C. based on an initial amount of the NH₃.

In some embodiments, flowing hydrogen through the reactor containing the catalyst to reduce the catalyst occurs at a temperature of 300 to 400° C.

In some embodiments, flowing hydrogen through the reactor containing the catalyst to reduce the catalyst occurs at a temperature of 650 to 750° C.

In some embodiments, the metal-doped LaMnO₃ material has a perovskite structure.

In another embodiment, a method of making the metal-doped LaMnO₃ material is described. The method includes dissolving a manganese salt and a lanthanum salt at a molar ratio of 1:2 to 2:1 in water at a temperature of 40 to 60° C. to form a mixture, adding an acid solution to the mixture, adding ethylene glycol to the mixture to form a gel, drying the gel at a temperature of 105 to 115° C. for 20 to 28 hours (h), drying the gel at a temperature of 125 to 135° C. to form a dried material, calcinating the dried material at a temperature of 450 to 550° C. for 4 to 6 h, calcinating the dried material at a temperature of 950 to 1050° C. for 8 to 12 h to form a LaMnO₃ perovskite, mixing the LaMnO₃ perovskite with the at least one metal, and calcinating the LaMnO₃ perovskite with the at least one metal at a temperature of 450 to 550° C. for 4 to 6 h to form the metal-doped LaMnO₃ material.

In some embodiments, the acid is a citric acid.

In some embodiments, the calcinating occurs with a ramping temperature of 3 to 5 degrees Celsius per minute (° C./min).

In some embodiments, at least 99 wt. % of NH₃ is decomposed to form H₂ and N₂ at a temperature of 500° C. based on an initial amount of the NH₃.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flow chart of a method of ammonia (NH₃) decomposition, according to certain embodiments.

FIG. 1B is a flow chart of a method of making a metal-doped lanthanum manganite (LaMnO₃) material, according to certain embodiments.

FIG. 2 depicts X-ray diffraction (XRD) patterns of nickel-(Ni) and cobalt-(Co) doped LaMnO₃ catalysts and 0.5% ruthenium-(Ru) impregnated Ni— and Co— doped LaMnO₃ catalysts, according to certain embodiments.

FIG. 3A is a scanning electron microscopy (SEM) image of 0.5% Ni—Co— doped LaMnO₃ (0.5Ni:0.5Co:LaMnO₃), according to certain embodiments.

FIG. 3B is an SEM image of 0.5Ni:0.25Co:LaMnO₃, according to certain embodiments.

FIG. 3C is an SEM image of 0.5Co:LaMnO₃, according to certain embodiments.

FIG. 3D is an SEM image of 0.5% Ru-impregnated 0.5Ni:0.5Co:LaMnO₃ ((0.5% Ru)0.5Ni:0.5Co:LaMnO₃), according to certain embodiments.

FIG. 3E is an SEM image of (0.5% Ru)0.5Ni:0.25Co:LaMnO₃, according to certain embodiments.

FIG. 3F is an SEM image of (0.5% Ru)0.5Co:LaMnO₃, according to certain embodiments.

FIG. 4A is a transmission electron microscopy (TEM) image of 0.5Ni:0.5Co:LaMnO₃, according to certain embodiments.

FIG. 4B is a TEM image of 0.5Ni:0.25Co:LaMnO₃, according to certain embodiments.

FIG. 4C is a TEM image of 0.5Co:LaMnO₃, according to certain embodiments.

FIG. 4D is a TEM image of (0.5% Ru)0.5Ni:0.5Co:LaMnO₃, according to certain embodiments.

FIG. 4E is a TEM image of (0.5% Ru)0.5Ni:0.25Co:LaMnO₃, according to certain embodiments.

FIG. 4F is a TEM image of (0.5% Ru)0.5Co:LaMnO₃, according to certain embodiments.

FIG. 5 is a graph depicting catalytic activity of Ru—NiCo/LaMnO₃ catalysts for NH₃ decomposition, according to certain embodiments.

FIG. 6 is a graph depicting effects of reducing temperature on catalytic activity of Ru—NiCo/LaMnO₃ catalysts for NH₃ decomposition, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, reference numerals will be used to designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

As used herein, the term “amount” refers to the level and/or concentration of one or more reactants, catalysts, and/or materials present in a reaction mixture.

As used herein, the term “compound” refers to a chemical entity, regardless of its phase (solid, liquid, or gaseous) and/or state-crude mixture, purified, or isolated.

As used herein, the term “nanoparticles (NPs)” refers to particles having a particle size of 1 nanometer (nm) to 500 nm within the scope of the present disclosure.

As used herein, the term “particle size” refers to the length or longest dimension of a particle.

As used herein, the term “calcination” refers to heating a compound to a high temperature, under a restricted supply of ambient oxygen. This is performed to remove impurities or volatile substances and to incur thermal decomposition.

As used herein, the term “catalyst” refers to a substance that speeds up a chemical reaction without being consumed or permanently changed in the process.

As used herein, the term “supported catalyst” refers to a catalytic substance that is dispersed on a solid support material, which may improve stability, dispersion, and/or reactivity of the catalytic substance in chemical reactions.

As used herein, the term “thermal decomposition (or thermolysis)” refers to a chemical decomposition initiated by heat. The decomposition temperature is the temperature at which a substance undergoes chemical decomposition.

As used herein, the term “ammonia (NH₃) decomposition” refers to a process of breaking down ammonia into nitrogen (N₂) and hydrogen (H₂) gases, typically under high temperature or catalytic conditions. For example: 2NH₃→N₂+3H₂

As used herein, the term “gas hourly space velocity (GHSV)” refers to a ratio of the rate of gas flow to the volume of catalyst in a reactor.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium, and isotopes of carbon include ¹³C and ¹⁴C. Isotopes of oxygen include ¹⁶O, ¹⁷O, and ¹⁸O. Isotopes of naturally occurring nickel (Ni) include ⁵⁸Ni, ⁶⁰Ni, ⁶¹Ni, ⁶²Ni, and ⁶⁴Ni. Isotopes of cobalt (Co) are ⁵⁶Co, ⁵⁷Co, ⁵⁸Co, and ⁶⁰Co. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

Aspects of the present disclosure are directed towards a catalytic activity of bimetallic catalysts [nickel (Ni) and cobalt (Co)] supported on lanthanum manganite material (LaMnO₃) for ammonia (NH₃) decomposition. Addition of ruthenium (Ru) further augmented the catalytic activity, leading to improved efficiency in ammonia cracking. The catalyst showed improvement in activity results leading to enhanced H₂ and N₂ production.

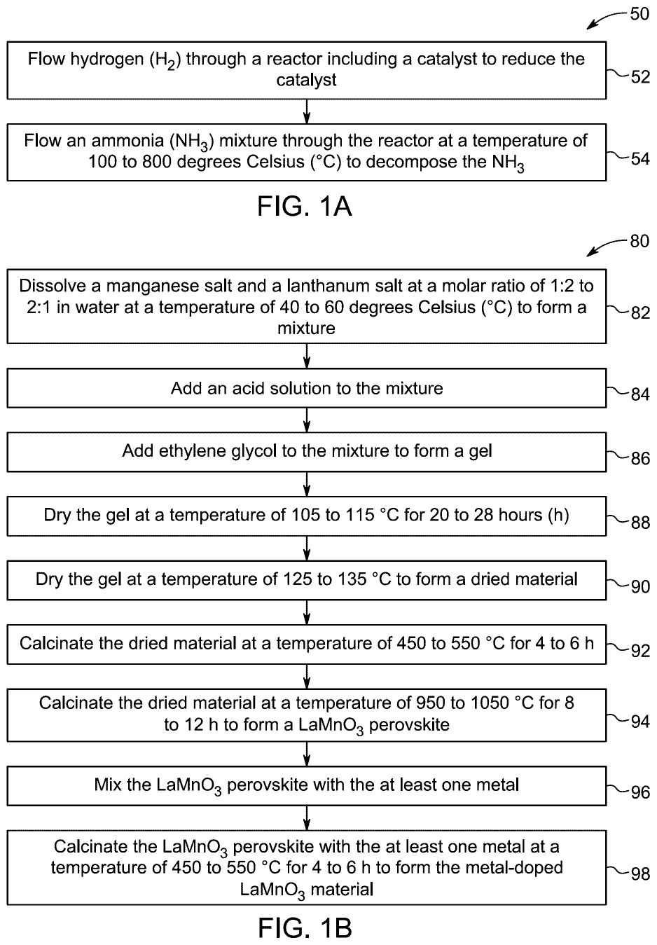

FIG. 1A illustrates a flow chart of a method 50 of NH₃ decomposition. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes flowing hydrogen (H₂) through a reactor containing a catalyst to reduce the catalyst. In some embodiments, the reactor is selected from the group including a fixed-bed reactor, a fixed bed tubular reactor, a trickle-bed reactor, a moving bed reactor, a rotating bed reactor, a fluidized bed reactor, and a slurry reactor. In a preferred embodiment, the reactor is a fixed bed tubular reactor.

In some embodiments, flowing hydrogen through the reactor containing the catalyst to reduce the catalyst occurs at a reactor temperature of 300-750 degrees Celsius (° C.), preferably 310-740° C., preferably 320-730° C., preferably 330-720° C., preferably 340-710° C., preferably 350-700° C., preferably 360-690° C., preferably 370-680° C., preferably 380-670° C., preferably 390-660° C., preferably 400-650° C., preferably 410-640° C., preferably 420-630° C., preferably 430-620° C., preferably 440-610° C., preferably 450-600° C., preferably 460-590° C., preferably 470-580° C., preferably 480-570° C., preferably 490-560° C., preferably 500-550° C., preferably 510-540° C., and preferably 520-530° C.

In some embodiments, flowing H₂ through the reactor containing the catalyst to reduce the catalyst occurs at a temperature of 300-400° C., preferably 310-390° C., preferably 320-380° C., preferably 330-370° C., more preferably 340-360° C., and yet more preferably about 350° C. In an embodiment, flowing H₂ through the reactor containing the catalyst to reduce the catalyst occurs at a reactor temperature of 350° C. In some embodiments, flowing H₂ through the reactor containing the catalyst to reduce the catalyst occurs at a temperature of 650-750° C., preferably 660-740° C., preferably 670-730° C., preferably 680-720° C., more preferably 690-710° C., and yet more preferably about 700° C. In an embodiment, flowing H₂ through the reactor containing the catalyst to reduce the catalyst occurs at a reactor temperature of 700° C.

In some embodiments, a flow rate of the H₂ through the reactor is 25-35 milliliters per minute (mL/min), preferably 26-34 mL/min, preferably 27-33 mL/min, preferably 28-32 mL/min, more preferably 29-31 mL/min, and yet more preferably about 30 mL/min. In a preferred embodiment, the flow rate of the H₂ through the reactor is 30 mL/min.

The catalyst is a metal-doped lanthanum manganite (LaMnO₃) material including cobalt (Co) and nickel (Ni) each in an amount of 0.1-2.0 wt. %, preferably 0.2-1.9 wt. %, preferably 0.3-1.8 wt. %, preferably 0.4-1.7 wt. %, preferably 0.5-1.6 wt. %, preferably 0.6-1.5 wt. %, preferably 0.7-1.4 wt. %, preferably 0.8-1.3 wt. %, preferably 0.9-1.2 wt. %, and preferably 1.0-1.1 wt. %, based on a total weight of the metal-doped LaMnO₃ material.

LaMnO₃ is used as a support material for catalytic applications due to several characteristics that enhance its effectiveness in various catalytic processes. First, its perovskite crystal structure offers good structural stability, ensuring long-term performance under harsh reaction conditions. This stability is used for maintaining the integrity of the catalyst-support system, thereby prolonging catalyst lifespan. Additionally, LaMnO₃ exhibits redox activity, which can promote redox reactions involved in many catalytic processes. This redox activity enables LaMnO₃ to participate actively in catalytic cycles, facilitating reaction pathways and enhancing catalytic efficiency. Furthermore, the presence of oxygen vacancies within the LaMnO₃ lattice provides additional active sites for catalytic reactions, further augmenting its catalytic performance.

The metal-doped LaMnO₃ material may have different morphologies, such as spheres, cones, cuboidal, needles, pyramidical, cylindrical, wires, crystals, rectangles, triangles, prisms, disks, cubes, ribbons, blocks, beads, discs, barrels, granules, whiskers, flakes, foils, powders, boxes, stars, flowers, polygonal like trigonal, pentagonal, hexagonal, mixtures thereof, and the like. In an embodiment, the metal-doped LaMnO₃ material is in the form of aggregated spheres having a longest dimension of 50-500 nm, preferably 70-480 nm, preferably 90-460 nm, preferably 110-440 nm, preferably 130-420 nm, preferably 150-400 nm, preferably 170-380 nm, preferably 190-360 nm, preferably 210-340 nm, preferably 230-320 nm, preferably 250-300 nm, and preferably 270-280 nm.

In some embodiments, the metal-doped LaMnO₃ material includes Co in an amount of 0.4-0.6 wt. %, preferably 0.41-0.59 wt. %, preferably 0.42-0.58 wt. %, preferably 0.43-0.57 wt. %, preferably 0.44-0.56 wt. %, preferably 0.45-0.55 wt. %, preferably 0.46-0.54 wt. %, preferably 0.47-0.53 wt. %, preferably 0.48-0.52 wt. %, more preferably 0.49-0.51 wt. %, and yet more preferably about 0.5 wt. % based on a total weight of the metal-doped LaMnO₃ material. In a preferred embodiment, the metal-doped LaMnO₃ material includes Co in an amount of 0.5 wt. % based on a total weight of the metal-doped LaMnO₃ material.

In some embodiments, the metal-doped LaMnO₃ material includes Co in an amount of 0.4-0.6 wt. %, preferably 0.41-0.59 wt. %, preferably 0.42-0.58 wt. %, preferably 0.43-0.57 wt. %, preferably 0.44-0.56 wt. %, preferably 0.45-0.55 wt. %, preferably 0.46-0.54 wt. %, preferably 0.47-0.53 wt. %, preferably 0.48-0.52 wt. %, more preferably 0.49-0.51 wt. %, and yet more preferably about 0.5 wt. % and Ni in an amount of 0.4-0.6 wt. %, preferably 0.41-0.59 wt. %, preferably 0.42-0.58 wt. %, preferably 0.43-0.57 wt. %, preferably 0.44-0.56 wt. %, preferably 0.45-0.55 wt. %, preferably 0.46-0.54 wt. %, preferably 0.47-0.53 wt. %, preferably 0.48-0.52 wt. %, more preferably 0.49-0.51 wt. %, and yet more preferably about 0.5 wt. % based on a total weight of the metal-doped LaMnO₃ material. In a preferred embodiment, the metal-doped LaMnO₃ material includes Co in an amount of 0.5 wt. % and Ni in an amount of 0.5 wt. % based on a total weight of the metal-doped LaMnO₃ material.

In other embodiments, the metal-doped LaMnO₃ material includes Co in an amount of 0.2-0.3 wt. %, preferably 0.21-0.29 wt. %, preferably 0.22-0.28 wt. %, preferably 0.23-0.27 wt. %, more preferably 0.24-0.26 wt. %, and yet more preferably about 0.25 wt. % and Ni in an amount of 0.4-0.6 wt. %, preferably 0.41-0.59 wt. %, preferably 0.42-0.58 wt. %, preferably 0.43-0.57 wt. %, preferably 0.44-0.56 wt. %, preferably 0.45-0.55 wt. %, preferably 0.46-0.54 wt. %, preferably 0.47-0.53 wt. %, preferably 0.48-0.52 wt. %, more preferably 0.49-0.51 wt. %, and yet more preferably about 0.5 wt. % based on a total weight of the metal-doped LaMnO₃ material. In a preferred embodiment, the metal-doped LaMnO₃ material includes Co in an amount of 0.25 wt. % and Ni in an amount of 0.5 wt. % based on a total weight of the metal-doped LaMnO₃ material.

In some embodiments, the metal-doped LaMnO₃ material further comprises 0.1 to 1.0 wt. %, preferably 0.2-0.9 wt. %, preferably 0.3-0.8 wt. %, preferably 0.4-0.7 wt. %, and preferably 0.5-0.6 wt. % ruthenium (Ru) based on a total weight of the metal-doped LaMnO₃ material. In some embodiments, the metal-doped LaMnO₃ material includes Ru in an amount of 0.4-0.6 wt. %, preferably 0.41-0.59 wt. %, preferably 0.42-0.58 wt. %, preferably 0.43-0.57 wt. %, preferably 0.44-0.56 wt. %, preferably 0.45-0.55 wt. %, preferably 0.46-0.54 wt. %, preferably 0.47-0.53 wt. %, preferably 0.48-0.52 wt. %, more preferably 0.49-0.51 wt. %, and yet more preferably about 0.5 wt. % based on a total weight of the metal-doped LaMnO₃ material. In a preferred embodiment, the metal-doped LaMnO₃ material includes Ru in an amount of 0.5 wt. % based on a total weight of the metal-doped LaMnO₃ material.

The metal-doped LaMnO₃ material may have different morphologies, such as spheres, cones, cuboidal, needles, pyramidical, cylindrical, wires, crystals, rectangles, triangles, prisms, disks, cubes, ribbons, blocks, beads, discs, barrels, granules, whiskers, flakes, foils, powders, boxes, stars, flowers, polygonal like trigonal, pentagonal, hexagonal, mixtures thereof, and the like. In some embodiments, the metal-doped LaMnO₃ material is in the shape of aggregated particles having a longest dimension of 50-1000 nanometer (nm), preferably 100-950 nm, preferably 150-900 nm, preferably 200-850 nm, preferably 250-800 nm, preferably 300-750 nm, preferably 350-700 nm, preferably 400-650 nm, preferably 450-600 nm, and preferably 500-550 nm.

In some embodiments, the metal-doped LaMnO₃ material has a perovskite structure. A perovskite structure is a crystalline arrangement with the general formula ABX₃, where A and B are cations, and X is an anion, usually oxygen. This structure features a cubic lattice, with the A site cation surrounded by a network of B site cations and X anions, providing both stability and flexibility.

At step 54, the method 50 includes then flowing an NH₃ mixture through the reactor at a temperature of 100-800° C., preferably 110-790° C., preferably 120-780° C., preferably 130-770° C., preferably 140-760° C., preferably 150-750° C., preferably 160-740° C., preferably 170-730° C., preferably 180-720° C., preferably 190-710° C., preferably 200-700° C., preferably 210-690° C., preferably 220-680° C., preferably 230-670° C., preferably 240-660° C., preferably 250-650° C., preferably 260-640° C., preferably 270-630° C., preferably 280-620° C., preferably 290-610° C., preferably 300-600° C., preferably 310-590° C., preferably 320-580° C., preferably 330-570° C., preferably 340-560° C., preferably 350-550° C., preferably 360-540° C., preferably 370-530° C., preferably 380-520° C., preferably 390-510° C., preferably 400-500° C., preferably 410-490° C., preferably 420-480° C., preferably 430-470° C., and preferably 440-460° C. to decompose the NH₃.

The NH₃ mixture includes NH₃ and helium in a volumetric ratio of 5:95-15:85, preferably 6:94-14:86, preferably 7:93-13:87, preferably 8:92-12:88, preferably 9:91-11:89, and preferably about 10:90. In some embodiments, a flow rate of the NH₃ mixture through the reactor is 30-40 mL/min, preferably 31-39 mL/min, preferably 32-38 mL/min, preferably 33-37 mL/min, more preferably 34-36 mL/min, and yet more preferably about 35 mL/min.

In some embodiments, at least 50 wt. %, preferably at least 55 wt. %, preferably at least 60 wt. %, preferably at least 65 wt. %, preferably at least 70 wt. %, preferably at least 75 wt. %, preferably at least 80 wt. %, preferably at least 85 wt. %, and preferably at least 90 wt. % of NH₃ is decomposed to form H₂ and N₂ at a temperature of 450° C. based on an initial amount of the NH₃. In some embodiments, at least 75 wt. %, preferably at least 80 wt. %, preferably at least 85 wt. %, preferably at least 90 wt. %, preferably at least 95 wt. %, and preferably at least 98 wt. % of NH₃ is decomposed to form H₂ and N₂ at a temperature of 475° C. based on an initial amount of the NH₃.

At least 99 wt. %, preferably at least 99.1 wt. %, preferably at least 99.2 wt. %, preferably at least 99.3 wt. %, preferably at least 99.4 wt. %, preferably at least 99.5 wt. %, preferably at least 99.6 wt. %, preferably at least 99.7 wt. %, preferably at least 99.8 wt. %, and preferably at least 99.9 wt. % of NH₃ is decomposed to form H₂ and N₂ at a temperature of 550° C. based on an initial amount of the NH₃. In some embodiments, at least 99 wt. %, preferably at least 99.1 wt. %, preferably at least 99.2 wt. %, preferably at least 99.3 wt. %, preferably at least 99.4 wt. %, preferably at least 99.5 wt. %, preferably at least 99.6 wt. %, preferably at least 99.7 wt. %, preferably at least 99.8 wt. %, and preferably at least 99.9 wt. % of NH₃ is decomposed to form H₂ and N₂ at a temperature of 500° C. based on an initial amount of the NH₃.

FIG. 1B illustrates a flow chart of a method 80 of making the metal-doped LaMnO₃ material. The order in which the method 80 is described is not intended to be construed as a limitation, and any number of the described method steps can be combined in any order to implement the method 80. Additionally, individual steps may be removed or skipped from the method 80 without departing from the spirit and scope of the present disclosure.

At step 82, the method 80 includes dissolving a manganese salt and a lanthanum salt at a molar ratio of 1:2 to 2:1, preferably 1:1.75 to 1.75:1, preferably 1:1.5 to 1.5:1, more preferably 1:1.25 to 1.25:1, and yet more preferably about 1:1 in water at a temperature of 40-60° C., preferably 41-59° C., preferably 42-58° C., preferably 43-57° C., preferably 44-56° C., preferably 45-55° C., preferably 46-54° C., preferably 47-53° C., preferably 48-52° C., more preferably 49-51° C., and yet more preferably about 50° C. to form a mixture. The reactants may be mixed manually or with the help of a stirrer. In a preferred embodiment, the method 80 includes dissolving a manganese salt and a lanthanum salt at a molar ratio of 1:1 in water at a temperature of 50° C. via stirring to form a mixture.

Suitable examples of manganese salts may include, but are not limited to, manganese chloride, manganese acetate, manganese sulfate, manganese nitrate, manganese carbonate, manganese phosphate, manganese bromide, manganese oxide, manganese fluoride and/or its hydrate, mixtures thereof, and the like. In a preferred embodiment, the manganese salt is manganese nitrate ([Mn(NO₃)₂·4H₂O]). Suitable examples of lanthanum salts may include, but are not limited to, lanthanum chloride, lanthanum nitrate, lanthanum acetate, lanthanum sulfate, lanthanum carbonate, lanthanum fluoride, lanthanum oxide and/or its hydrate, mixtures thereof, and the like. In a preferred embodiment, the lanthanum salt is lanthanum nitrate ([La(NO₃)₃·6H₂O]). The water may be tap water, distilled water, bidistilled water, deionized water, deionized distilled water, reverse osmosis water, a combination thereof, and/or some other water. In a preferred embodiment, the water is deionized water.

At step 84, the method 80 includes adding an acid solution to the mixture. Suitable examples of acids may include, but are not limited to, sulfuric acid, hydrochloric acid, nitric acid, acetic acid, phosphoric acid, citric acid, formic acid, oxalic acid, tartaric acid, lactic acid, boric acid, hydrofluoric acid, malic acid, perchloric acid, a combination thereof, and the like. In a preferred embodiment, the acid is a citric acid.

At step 86, the method 80 includes adding ethylene glycol to the mixture to form a gel. Ethylene glycol acts as a solvent to promote gel formation and helps stabilize the mixture, ensuring an even distribution of components and controlling the consistency of the gel for the subsequent stages of the process. In alternate embodiments, solvents for forming a gel may include, but are not limited to, glycerol, propylene glycol, diethylene glycol, polyethylene glycol, a combination thereof, and the like.

At step 88, the method 80 includes drying the gel at a temperature of 105-115° C., preferably 106-114° C., preferably 107-113° C., preferably 108-112° C., more preferably 109-111° C., and yet more preferably about 110° C. for 20-28 hours (h), preferably 21-27 h, preferably 22-26 h, more preferably 23-25 h, and yet more preferably about 24 h. In a preferred embodiment, the method includes drying the gel at a temperature of 110° C. for 24 h. The gel is transformed into a semi-solid form by evaporating excess solvent.

At step 90, the method 80 includes drying the gel at a temperature of 125-135° C., preferably 126-134° C., preferably 127-133° C., preferably 128-132° C., more preferably 129-131° C., and yet more preferably about 130° C. to form a dried material. The gel may be dried by using heating appliances such as ovens, vacuum ovens, microwaves, autoclaves, hot plates, heating mantles and tapes, oil baths, salt baths, sand baths, air baths, hot-tube furnaces, hot-air guns, a combination thereof, and the like. In a preferred embodiment, the drying is done in a hot air oven.

At step 92, the method 80 includes calcinating the dried material at a temperature of 450-550° C., preferably 460-540° C., preferably 470-530° C., preferably 480-520° C., more preferably 490-510° C., and yet more preferably about 500° C. for 4-6 h, preferably 4.5-5.5 h, and more preferably about 5 h. Calcination is carried out by heating to a high temperature, under a restricted supply of ambient oxygen. This is performed to remove impurities or volatile substances and to incur thermal decomposition. Typically, the calcination is carried out in a furnace preferably equipped with a temperature control system, which may provide a heating rate of up to 50 degrees Celsius/minute (° C./min), preferably up to 40° C./min, preferably up to 30° C./min, preferably up to 20° C./min, preferably up to 10° C./min, preferably up to 5° C./min, preferably up to 4° C./min, and preferably up to 3° C./min. In some embodiments, the calcinating occurs with a ramping temperature of 3-5° C./min, preferably 3.5-4.5° C./min, and preferably up to 4° C./min. In a preferred embodiment, the calcination of the dried material is done at a temperature of 500° C. for 4 h at a ramping temperature of 4° C./min.

At step 94, the method 80 includes calcinating the dried material at a temperature of 950-1050° C., preferably 960-1040° C., preferably 970-1030° C., preferably 980-1020° C., more preferably 990-1010° C., and yet more preferably about 1000° C. for 8-12 h, preferably 9-11 h, and more preferably about 10 h to form a LaMnO₃ perovskite. In a preferred embodiment, the calcination of the dried material is done at a temperature of 1000° C. for 10 h to form a LaMnO₃ perovskite.

At step 96, the method 80 includes mixing the LaMnO₃ perovskite with the at least one metal. Mixing techniques include, but are not limited to, stirring, sonication, rotary drum mixing, planetary mixing, high-shear mixing, vortex mixing, ribbon blending, hand mixing, ball milling, a combination thereof, and the like.

At step 98, the method 80 includes calcinating the LaMnO₃ perovskite with at least one metal at a temperature of 450-550° C., preferably 460-540° C., preferably 470-530° C., preferably 480-520° C., more preferably 490-510° C., and yet more preferably about 500° C. for 4-6 h, preferably 4.5-5.5 h, and more preferably about 5 h to form the metal-doped LaMnO₃ material. In a preferred embodiment, the method includes calcinating the LaMnO₃ perovskite with at least one metal at a temperature of 500° C. for 5 h at ramping temperature of 4° C./min to form the metal-doped LaMnO₃ material.

### EXAMPLES

The following examples describe and demonstrate a method of ammonia (NH₃) decomposition using bimetallic catalysts supported on lanthanum manganite (LaMnO₃). The examples are provided solely for illustration and are not to be construed as limitations of the present disclosure, as many variations thereof are possible without departing from the spirit and scope of the present disclosure.

### Example 1: Chemicals

All chemicals were purchased from Sigma-Aldrich and used as received. Dry and deoxygenated solvents were produced using standard procedures wherever needed. Deionized water (DI) (specific conductivity: 18/2 megaohms w(MΩ)) was used in all experiments.

### Example 2: Synthesis of LaMnO₃ Perovskite

The LaMnO₃ perovskite material was prepared using a modified sol-gel procedure. A stoichiometric amount of manganese nitrate (Mn(NO₃)₂·4H₂O) (6.6 grams (g), 26.3 millimoles (mmol)) and lanthanum nitrate (La(NO₃)₃·6H₂O) (11.4 g, 26.3 mmol) was dissolved in 20 milliliters (mL) DI-water and stirred continuously at 50° C. mixture until complete dissolution. Then, freshly prepared 5 mole equivalent citric acid (27.8 g, 132 mmol) in water (30 mL) (also referred to as a citric acid solution) was added to the mixed solution. The solution started to turn turbid at 50° C. To this, ethylene glycol (11 mL, 198 mmol) (ethylene glycol:citric acid=1.5:1) was added to facilitate gel formation. The temperature of the mixture was raised to 90° C. and continuously stirring until the gel formation was completed.

The obtained gel was further concentrated by evaporating the excess solvent by keeping it in the oven at 110 degrees Celsius (° C.) for 24 hours (h) and then drying it at 130° C. The dried material was calcined in air at 500° C. with a temperature gradient of 4 degrees Celsius/minute (° C./min) and a holding temperature of 5 h to form a resin-like black color substance. This sample was further calcined at 1000° C. in air for another 10 h to obtain a black color crystalline material for further use.

### Example 3: Synthesis of Cobalt Nickel (Co—Ni) Doped LaMnO₃ (CoNi/LaMnO₃)

The catalysts were prepared using a dry mix method without using any solvent. Firstly, Co(NO₃)₂·6H₂O and Ni(NO₃)₂·6H₂O were added to LaMnO₃ (1 g) in different ratios ((0.5_{Ni}:0.5_{Co}), (0.5_{Ni}:0.25_{Co}), and (0.5_{CO})), and grinded with a mortar pestle for 30 minutes (min). The resultant solid mixture was calcined at 500° C. in the air with a temperature ramp of 4° C./min and a holding time of 5 h.

### Example 4: Synthesis of Ru-Impregnated in CoNi/LaMnO₃ Composites

The ruthenium-impregnated CoNi/LaMnO₃ composites were prepared using a dry mix method as well. The same procedure was followed with the addition of adding Ru precursors into the calcined samples. 0.5% Ru was added in the form of ruthenium nitrate (Ru(NO₃)) (2 milligrams (mg)) to each calcined samples of CoNi/LaMnO₃ composite and grinded again to form (0.5_{Ni}:0.5_{CO}) 0.5% ruthenium (Ru), (0.5_{Ni}:0.25_{CO}) 0.5% Ru, and (0.5_{CO}) 0.5% Ru CoNi/LaMnO₃ composite mixtures. Subsequently, the obtained mixture was treated with heat at 500° C. for another 5 h with a temperature gradient of 3° C./min.

### Example 5: Characterization

X-ray diffraction (XRD) patterns were acquired using a Rigaku model Ultima-IV diffractometer equipped with Cu-Kα radiation (λ=1.5406 angstrom (Å)) operating at 40 kV and 25 mA. The measurements were conducted over a 20 range spanning from 20 to 130 degrees (°) under ambient air conditions. For scanning electron microscopy (SEM) analysis, samples were prepared by depositing ethanolic suspensions onto single-sided alumina tape affixed to alumina stubs. Elemental analysis and mapping were performed using energy-dispersive X-ray spectroscopy (EDS) with a Lyra 3 attachment on the SEM instrument, manufactured by Tescan in the Czech Republic.

### Example 6: Catalytic Activity Experiments

A fixed bed tubular reactor made of stainless steel, with dimensions of 12.7 millimeters (mm) in diameter and 280 mm in length, was utilized for the NH₃ decomposition process. The reactor contained 0.1 g of catalyst and operated under atmospheric pressure conditions, with a quartz wool plug was positioned below the catalyst bed. To monitor the temperature within the reactor, a K-type thermocouple was placed at the center of the catalyst bed. Prior to commencing the reaction, the catalyst underwent a reduction process by subjecting it to a hydrogen gas (H₂) stream at a flow rate of 30 milliliters per minute (mL/min). The reduction process involved ramping the temperature from 650° C. to 700° C. at a rate of 5° C./min, followed by maintaining the temperature at 700° C. for 20 min. Subsequently, any remaining H₂ gas was purged using helium gas (He). The reactor temperature was then adjusted to experimental conditions while maintaining a constant flow rate of helium gas.

During the reaction, a diluted mixture of NH₃ with a concentration of 10% by volume, balanced with helium gas, was introduced into the catalyst bed. The flow rate of this mixture through the catalyst bed was set at 34 mL/min, corresponding to an equivalent space velocity of 20,400 liters per kilogram of catalyst per hour (L/Kgcat/h). The conversion of NH₃ was assessed once the reaction conditions reached a stable state. To quantify the NH₃ concentration, an Agilent 7890B gas chromatograph (GC) equipped with a thermal conductivity detector (TCD) was employed. Gas chromatography analysis was performed isothermally at 50° C. using an HP-PLOT U column with dimensions of 30 meters (m) in length and 0.32 mm in internal diameter. Helium gas was used as the carrier gas for the gas composition analysis. NH₃ conversion was calculated based on equation 1.

$${NH}_{3} conversion = \frac{{NH}_{3 , in} - {NH}_{3 , out}}{{NH}_{3 , in}} \times 100 \% \qquad ( 1 )$$

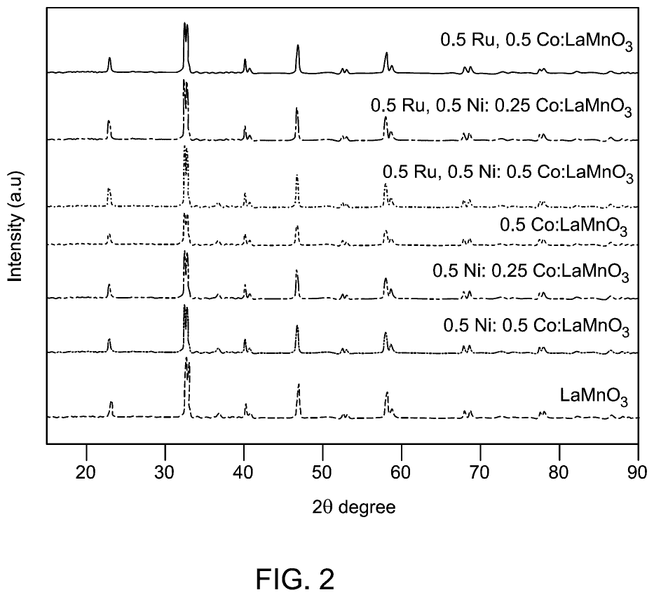

XRD analysis was employed to investigate the structural impact of doping LaMnO₃ with Co, Ni, and Ru as shown in FIG. 2. Despite the incremental addition of the dopants, the XRD patterns revealed no discernible changes in the crystal structure of LaMnO₃. The characteristic peaks corresponding to the perovskite structure of LaMnO₃ remained unchanged, indicating that the introduction of Co, Ni, and Ru did not alter the lattice parameters and/or induce phase transitions detectable by this method. These findings suggest that the dopants were either incorporated into the LaMnO₃ lattice without affecting its symmetry or that any resultant structural modifications were below the detection limit of the XRD analysis.

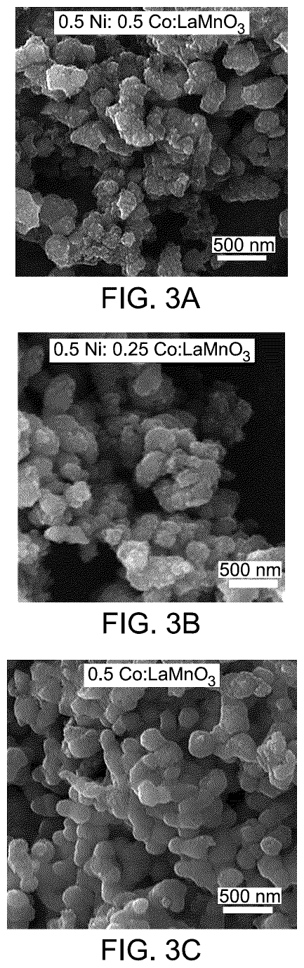

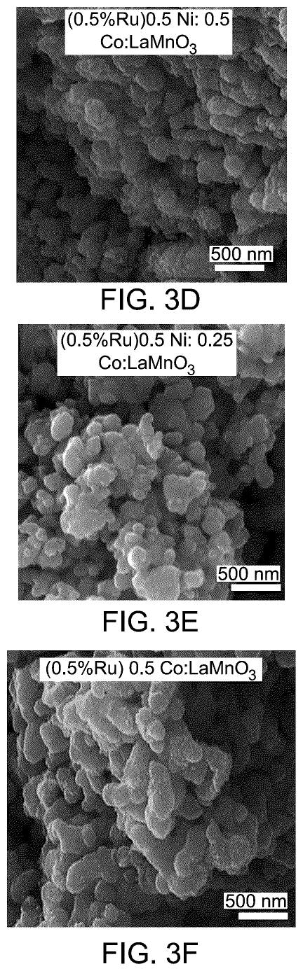

Structural examination of the CoNi/LaMnO₃ catalysts and their Ru-impregnated counterparts was done using SEM. FIGS. 3A-3C depict SEM images of 0.5Ni:0.5Co:LaMnO₃, 0.5Ni:0.25Co:LaMnO₃, and 0.5Co:LaMnO₃, respectively. FIGS. 3D-3F depict SEM images of 0.5% Ru-impregnated 0.5Ni:0.5Co:LaMnO₃ ((0.5% Ru) 0.5Ni:0.5Co:LaMnO₃), 0.5% Ru-impregnated 0.5Ni:0.25Co:LaMnO₃, ((0.5% Ru) 0.5Ni:0.25Co:LaMnO₃), and 0.5% Ru-impregnated 0.5Co:LaMnO₃ ((0.5% Ru) 0.5Co:LaMnO₃), respectively. A pronounced agglomeration of particles was observed, indicating a departure from the dispersed catalyst structure. SEM analysis did not reveal distinct crystal structures within the agglomerates for both sets of catalysts. This morphology suggests that the doping and impregnation processes, intended to modify the catalysts' surface and structural properties, may lead to formation of dense, aggregated domains rather than promoting a homogeneous dispersion of dopant elements. Such agglomeration could mask the crystallographic features of the LaMnO₃ matrix, potentially impacting accessibility and reactivity of active sites.

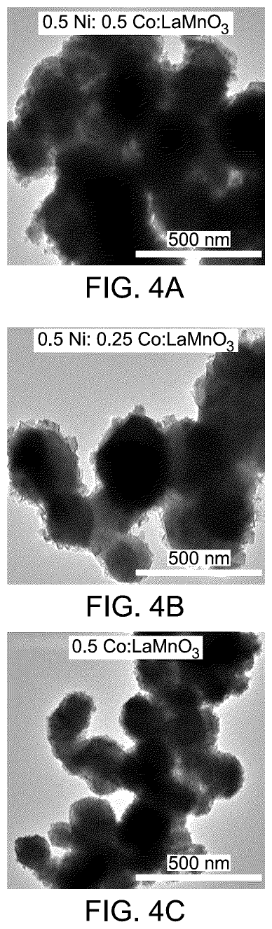

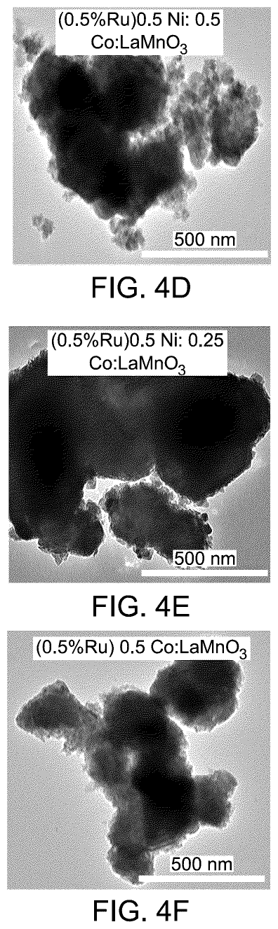

In the transmission electron microscopy (TEM) analysis conducted on the CoNi/LaMnO₃ catalysts and their Ru-impregnated variants, an absence of distinct nanoparticles was observed, as depicted in FIGS. 4A-4F. FIGS. 4A-4C depict TEM images of 0.5Ni:0.5Co:LaMnO₃, 0.5Ni:0.25 Co:LaMnO₃, and 0.5Co:LaMnO₃, respectively. FIGS. 4D-4F depict TEM images of (0.5% Ru) 0.5Ni:0.5Co:LaMnO₃, (0.5% Ru) 0.5Ni:0.25Co:LaMnO₃, and (0.5% Ru) 0.5Co:LaMnO₃, respectively. The TEM images predominantly feature areas of particle agglomeration. This agglomeration suggests that during the synthesis or doping process, conditions favored the clustering of material, leading to the formation of larger aggregates rather than discrete nanoparticles. The TEM findings point towards the influence of synthesis conditions on particle size and dispersion.

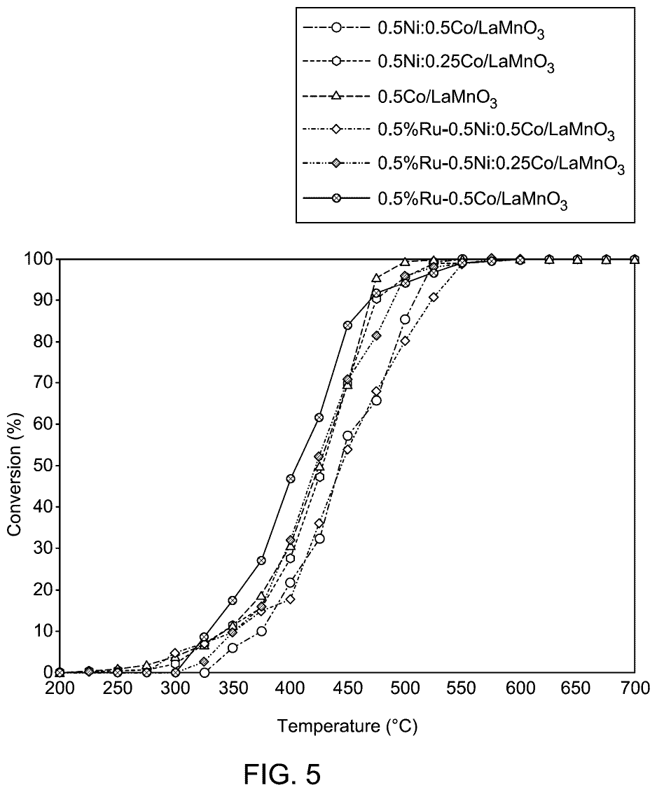

Catalytic performances of the various catalysts, 0.5Ni:0.5Co:LaMnO₃, 0.5Ni:0.25 Co:LaMnO₃, 0.5Co:LaMnO₃, and the corresponding 0.5% Ru-impregnated catalysts for the decomposition of NH₃ are depicted in FIG. 5. 100 mg of the reduced catalyst was loaded in the reactor and a gas hourly space velocity (GHSV) of 24,000 milliliters per gram of catalyst per hour (mLg_{cat}⁻¹ h⁻¹) of NH₃ was maintained. FIG. 5 depicts that the NH₃ cracking was initiated after 200° C., and the rate of decomposition of NH₃ was increased with the increase in temperature. When the temperature was increased from 350° C. to 500° C., there is a sharp increase in the decomposition of NH₃. 0.5Co:LaMnO₃ performed better towards NH₃ decomposition in comparison to 0.5Ni:0.5Co:LaMnO₃ and 0.5Ni:0.25Co:LaMnO₃. When 0.5% Ru is impregnated with 0.5Co:LaMnO₃, the catalytic activity is boosted and the NH₃ conversion is obtained sharply; however, when the temperature was increased beyond 475° C., its activity was found to be decreasing and >99% conversion was achieved at 550° C. When the Ni was added to Co, catalytic activity was decreased.

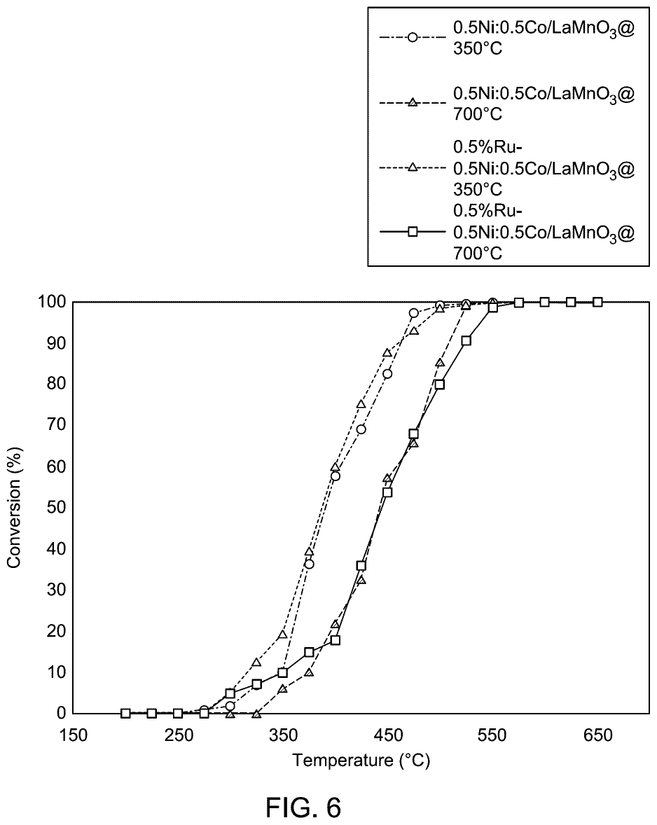

Effect of reduction temperature on the catalytic activity of 0.5Ni:0.5Co:LaMnO₃ and (0.5% Ru) 0.5Ni:0.5Co:LaMnO₃. Initially, the catalysts were reduced at 700° C. and their activity towards NH₃ decomposition was observed; however, adding Ni was resulting in the lower activity of the catalyst. The catalysts were then reduced at 350° C. and their activity was investigated under experimental conditions. The results are shown in FIG. 6 and there was a sharp increase in the catalytic activity. NH₃ decomposition rate was higher when the catalyst was reduced at 350° C. in comparison to being reduced at 700° C. The decrease in activity of nickel when reduced at 700° C. may be attributed to the formation of less active species, such as nickel hydride, and potential surface restructuring and/or sintering, which may reduce the availability of active catalytic sites. Additionally, the presence of other species might lead to surface poisoning, further diminishing the catalytic activity of nickel.

Bimetallic catalysts supported on LaMnO₃ for NH₃ decomposition may address pressing needs for efficient H₂ production methods. A nuanced relationship between reduction temperature and catalytic activity is observed, with the Ni-doped catalyst exhibiting enhanced performance at a 350° C. reduction while Co-doped catalysts display promising activity at a 700° C. reduction. All catalysts achieve NH₃ conversion with rates exceeding 99% beyond 500° C., underscoring their potential applicability in industrial H₂ production processes. These findings contribute to advancing the understanding of catalyst design for efficient NH₃ decomposition, thereby facilitating the development of sustainable H₂ generation technologies.

Numerous modifications and variations of the present disclosure are possible in light of the above teachings. Therefore, it is to be understood that within the scope of the appended claims, the disclosure may be practiced other than as specifically described herein.

1: A method of ammonia (NH₃) decomposition, including:
flowing hydrogen (H₂) through a reactor containing a catalyst to reduce the catalyst,
wherein the catalyst is a metal-doped lanthanum manganite material (LaMnO₃) including cobalt (Co) and nickel (Ni) each in an amount of 0.1 to 2.0 percent by weight (wt. %) based on a total weight of the metal-doped LaMnO₃ material,
then, flowing an NH₃ mixture through the reactor at a temperature of 100 to 800 degrees Celsius (° C.) to decompose the NH₃,
wherein the NH₃ mixture includes NH₃ and helium in a volumetric ratio of 5:95 to 15:85,
wherein at least 99 wt. % of NH₃ is decomposed to form H₂ and N₂ at a temperature of 550° C. based on an initial amount of the NH₃.

2: The method of claim 1, wherein flowing H₂ through the reactor containing the catalyst to reduce the catalyst occurs at a reactor temperature of 300 to 750° C.

3: The method of claim 1, wherein a flow rate of the NH₃ mixture through the reactor is 30 to 40 milliliters per minute (mL/min).

4: The method of claim 1, wherein the metal-doped LaMnO₃ material is in the form of aggregated spheres having a longest dimension of 50 to 500 nanometers (nm).

5: The method of claim 1, wherein a flow rate of the H₂ through the reactor is 25 to 35 mL/min.

6: The method of claim 1, wherein the metal-doped LaMnO₃ material includes Co in an amount of 0.4 to 0.6 wt. % based on a total weight of the metal-doped LaMnO₃ material.

7: The method of claim 1, wherein the metal-doped LaMnO₃ material includes Co in an amount of 0.4 to 0.6 wt. % and Ni in an amount of 0.4 to 0.6 wt. % based on a total weight of the metal-doped LaMnO₃ material.

8: The method of claim 1, wherein the metal-doped LaMnO₃ material includes Co in an amount of 0.2 to 0.3 wt. % and Ni in an amount of 0.4 to 0.6 wt. % based on a total weight of the metal-doped LaMnO₃ material.

9: The method of claim 1, wherein the metal-doped LaMnO₃ material further comprises 0.1 to 1.0 wt. % of ruthenium (Ru) based on a total weight of the metal-doped LaMnO₃ material.

10: The method of claim 9, wherein the metal-doped LaMnO₃ material includes Ru in an amount of 0.4 to 0.6 wt. % based on a total weight of the metal-doped LaMnO₃ material.

11: The method of claim 9, wherein the metal-doped LaMnO₃ material is in the shape of aggregated particles having a longest dimension of 50 to 1000 nm.

12: The method of claim 1, wherein at least 50 wt. % of NH₃ is decomposed to form H₂ and N₂ at a temperature of 450° C. based on an initial amount of the NH₃.

13: The method of claim 1, wherein at least 75 wt. % of NH₃ is decomposed to form H₂ and N₂ at a temperature of 475° C. based on an initial amount of the NH₃.

14: The method of claim 1, wherein flowing hydrogen through the reactor containing the catalyst to reduce the catalyst occurs at a temperature of 300 to 400° C.

15: The method of claim 1, wherein flowing hydrogen through the reactor containing the catalyst to reduce the catalyst occurs at a temperature of 650 to 750° C.

16: The method of claim 1, wherein the metal-doped LaMnO₃ material has a perovskite structure.

17: The method of claim 1, wherein the metal-doped LaMnO₃ material is made by a process, including:
dissolving a manganese salt and a lanthanum salt at a molar ratio of 1:2 to 2:1 in water at a temperature of 40 to 60° C. to form a mixture;
adding an acid solution to the mixture;
adding ethylene glycol to the mixture to form a gel;
drying the gel at a temperature of 105 to 115° C. for 20 to 28 hours (h);
drying the gel at a temperature of 125 to 135° C. to form a dried material;
calcinating the dried material at a temperature of 450 to 550° C. for 4 to 6 h;
calcinating the dried material at a temperature of 950 to 1050° C. for 8 to 12 h to form a LaMnO₃ perovskite;
mixing the LaMnO₃ perovskite with the at least one metal; and
calcinating the LaMnO₃ perovskite with the at least one metal at a temperature of 450 to 550° C. for 4 to 6 h to form the metal-doped LaMnO₃ material.

18: The method of claim 17, wherein the acid is a citric acid.

19: The method of claim 17, wherein the calcinating occurs with a ramping temperature of 3 to 5 degrees Celsius/minute (° C./min).

20: The method of claim 6, wherein at least 99 wt. % of NH₃ is decomposed to form H₂ and N₂ at a temperature of 500° C. based on an initial amount of the NH₃.
